(19) United States
(12) Patent Application Publication
(10) Pub. No.: US 2015/0049117 A1
(43) Pub. Date: Feb. 19, 2015

(54) PROJECTOR AND METHOD OF CONTROLLING PROJECTOR

(71) Applicant: SEIKO EPSON CORPORATION, Tokyo (JP)

(72) Inventor: Shiki Furui, Matsumoto-shi (JP)

(21) Appl. No.: 14/374,321

(22) PCT Filed: Jan. 29, 2013
(86) PCT No.: PCT/JP2013/000446

§ 371 Date: Jul. 24, 2014

(30) Foreign Application Priority Data
Feb. 16, 2012 (JP) 2012-031447

(51) Int. Cl. G06T 5/00; G06T 5/50

(52) U.S. Cl. CPC G06T 5/006; G06T 5/50
USPC 345/634

(57) ABSTRACT

A projector (100) including a projection section (101) adapted to project an image on a screen (SC), a CPU (120) adapted to make the projection section project a correction pattern (177a) so as to be superimposed on the image presently projected if a start condition of the distortion correction process is satisfied, and a correction control section (122) and a keystone distortion correction section (132) adapted to perform the distortion correction process based on a state of the correction pattern, and the CPU makes the projection section project the correction pattern in a state in which a result of the distortion correction process fails to be reflected during a period from when the start condition of the distortion correction process is satisfied to when a condition for completing the distortion correction process is satisfied, and a period in which the keystone distortion correction section performs the distortion correction process a plurality of times.

### CROSS REFERENCE TO RELATED APPLICATIONS

The entire disclosure of Japanese Patent Application No. 2012-031447, filed Feb. 16, 2012 is expressly incorporated by reference herein.

### TECHNICAL FIELD

The present invention relates to a projector for projecting an image on a projection surface, and a method of controlling the projector.

### BACKGROUND ART

In the past, there has been known a projector for projecting an image on a projection surface, which is provided with a function of correcting a keystone distortion of the projection image (see, e.g., PTL1). The device of PTL1 projects a calibration image for correcting the image, and then repeatedly performs the keystone distortion correction based on the projection state of the calibration image to thereby perform the correction with accuracy.

### CITATION LIST

### Patent Literature

### [PTL 1]

JP-A-2010-130225

### SUMMARY OF INVENTION

### Technical Problem

Incidentally, in the case in which the process for correcting the distortion of the projection image is performed, and then the process for correcting the distortion is further performed as in the device described in PTL1, the image projected has already been corrected. Therefore, in the subsequent correction processes, it is necessary to calculate the correction amount while adding the distortion of the image presently projected and the content of the correction performed previously to each other. Therefore, the method of making it possible to reduce the load of the calculation related to the correction process has been desired.

### Solution to Problem

An advantage of some aspects of the invention is to provide a projector capable of performing the process of correcting the distortion of the projection image on the projection surface a plurality of times, and of reducing the load of the arithmetic processing related to the correction, and a method of controlling the projector.

An aspect of the invention is directed to a projector including a projection unit adapted to project an image on a projection surface, a controller adapted to make the projection unit project a correcting image so as to be superimposed on the image presently projected if a start condition of a distortion correction process adapted to correct a distortion of the image projected by the projection unit is satisfied, and a correction unit adapted to perform the distortion correction process based on a state of the correcting image projected by the projection unit, and the controller makes the projection unit project the correcting image in a state in which a result of the distortion correction process fails to be reflected during a period from when the start condition of the distortion correction process is satisfied to when a condition for completing the distortion correction process is satisfied, and a period in which the correction unit performs the distortion correction process a plurality of times.

According to this aspect of the invention, in the case of performing the distortion correction based on the state of the correcting image projected on the projection surface, the distortion correction process is not reflected on the correcting image, and the correcting image is projected until the distortion correction process is completed. Therefore, in the case of performing the distortion correction process a plurality of times, the distortion correction can be performed without adding the correction having already been performed. Thus, the process of correcting the distortion of the projection image on a projection surface can be performed a plurality of times, and at the same time, a load of arithmetic processing related to the correction can be reduced.

Another aspect of the invention is directed to the projector according to the above aspect of the invention, wherein the controller makes the projection unit project the correcting image in the state in which the result of the distortion correction process fails to be reflected, and makes the projection unit update the projection state of the image presently projected so as to reflect the result of the distortion correction process if the correction unit performs the distortion correction process.

According to this aspect of the invention, since the result of the process is reflected on the projection state of the image every time the distortion correction process is performed in the case in which the distortion correction process is performed a plurality of times, it is possible to inform the user of the change in the image by the distortion correction process in real time without waiting for the completion of the series of distortion correction processes.

Still another aspect of the invention is directed to the projector according to the above aspect of the invention, wherein the controller makes the projection unit project the correcting image in the state in which the result of the distortion correction process fails to be reflected, and makes the projection unit update the projection state of the image presently projected so as to be an intermediate state between a state reflecting the distortion correction process and a state before reflecting the distortion correction process if the correction unit performs the distortion correction process.

According to this aspect of the invention, the result of the process is reflected on the projection state of the image every time the distortion correction process is performed, and at the same time, the level of the change in the image can be reduced. Thus, in the case in which the distortion correction process is performed a plurality of times, it is possible to inform the user of the change in the image due to the distortion correction process in real time, and at the same time, the level of the change in the image is reduced to thereby prevent the uncomfortable feeling of the user.

Yet another aspect of the invention is directed to the projector according to the above aspect of the invention, wherein the controller makes the projection unit project the correcting image in the state in which the result of the distortion correction process fails to be reflected, and performs projection of showing a shape of the image after the distortion correction process if the correction unit performs the distortion correction process.

According to this aspect of the invention, since the shape of the image reflecting the result of the process is shown every time the distortion correction process is performed in the case in which the distortion correction process is performed a plurality of times, it is possible to inform the user of the change in the image by the distortion correction process without waiting for the completion of the series of distortion correction processes. Further, since the process of obtaining the shape of the image reflecting the result of the distortion correction process has the load smaller than that of the process of deforming the image, the load of the distortion correction process can be reduced.

Still yet another aspect of the invention is directed to the projector according to the above aspect of the invention, wherein the controller determines that the start condition of the distortion correction process is satisfied based on one of a movement of the projector and an external operation.

According to this aspect of the invention, it is possible to promptly start the distortion correction process, and for example, perform the distortion correction process a plurality of times with a reduced processing load.

Further another aspect of the invention is directed to the projector according to the above aspect of the invention, wherein the controller determines that the condition for completing the distortion correction process is satisfied based on one of a movement of the projector and an external operation.

According to this aspect of the invention, by continuously performing the distortion correction process until the condition is satisfied, the distortion of the projection image can surely and accurately be corrected.

Still further another aspect of the invention is directed to a method of controlling a projector including a projection unit adapted to project an image on a projection surface, the method including making the projection unit project a correcting image so as to be superimposed on the image presently projected if a start condition of a distortion correction process adapted to correct a distortion of the image projected by the projection unit is satisfied, performing the distortion correction process based on a state of the correcting image projected, and making the projection unit project the correcting image in a state in which a result of the distortion correction process fails to be reflected during a period from when the start condition of the distortion correction process is satisfied to when a condition for completing the distortion correction process is satisfied, and a period in which the distortion correction process is performed a plurality of times.

According to this aspect of the invention, in the case of performing the distortion correction based on the state of the correcting image projected on the projection surface, the distortion correction process is not reflected on the correcting image, and the correcting image is projected until the distortion correction process is completed. Therefore, in the case of performing the distortion correction process a plurality of times, the distortion correction can be performed without adding the correction having already been performed. Thus, the process of correcting the distortion of the projection image on a projection surface can be performed a plurality of times, and at the same time, a load of arithmetic processing related to the correction can be reduced,

### Advantageous Effects of Invention

According to the aspects of the invention, it is possible to perform the process of correcting the distortion of the projection image on the projection surface a plurality of times, and at the same time reduce the load of the arithmetic processing related to the correction.

### BRIEF DESCRIPTION OF DRAWINGS

FIG. 1 is a block diagram showing a configuration of a projector according to a first embodiment of the invention,

FIG. 2A is an explanatory diagram showing an action of the projector projecting an image and a correction pattern, and showing an example of the image.

FIG. 2B is an explanatory diagram showing an action of the projector projecting an image and a correction pattern, and showing an example of the correction pattern.

FIG. 2C is an explanatory diagram showing an action of the projector projecting an image and a correction pattern, and showing an example in which a light modulation device draws the image and the correction pattern.

FIG. 3A is an explanatory diagram showing an example of an action of the projector correcting the distortion of the projection image, and showing a projection example to the screen before the correction.

FIG. 3B is an explanatory diagram showing an example of an action of the projector correcting the distortion of the projection image, and showing an example of the image formed in an image formable area.

FIG. 3C is an explanatory diagram showing an example of an action of the projector correcting the distortion of the projection image, and showing a projection example to the screen after the correction.

FIG. 4 is a flowchart showing an action of the projector according to the first embodiment.

FIG. 5A is an explanatory diagram showing an example of an action of the projector correcting the distortion of the projection image in a second embodiment, and showing a projection example to the screen before the correction,

FIG. 5B is an explanatory diagram showing an example of an action of the projector correcting the distortion of the projection image in the second embodiment, and showing an example of the image formed in an image formable area.

FIG. 5C is an explanatory diagram showing an example of an action of the projector correcting the distortion of the projection image in the second embodiment, and showing a projection example to the screen after the correction.

FIG. 6 is a flowchart showing an action of the projector according to the second embodiment.

### DESCRIPTION OF EMBODIMENTS

### First Embodiment

An embodiment to which the invention is applied will hereinafter be explained with reference to the accompanying drawings.

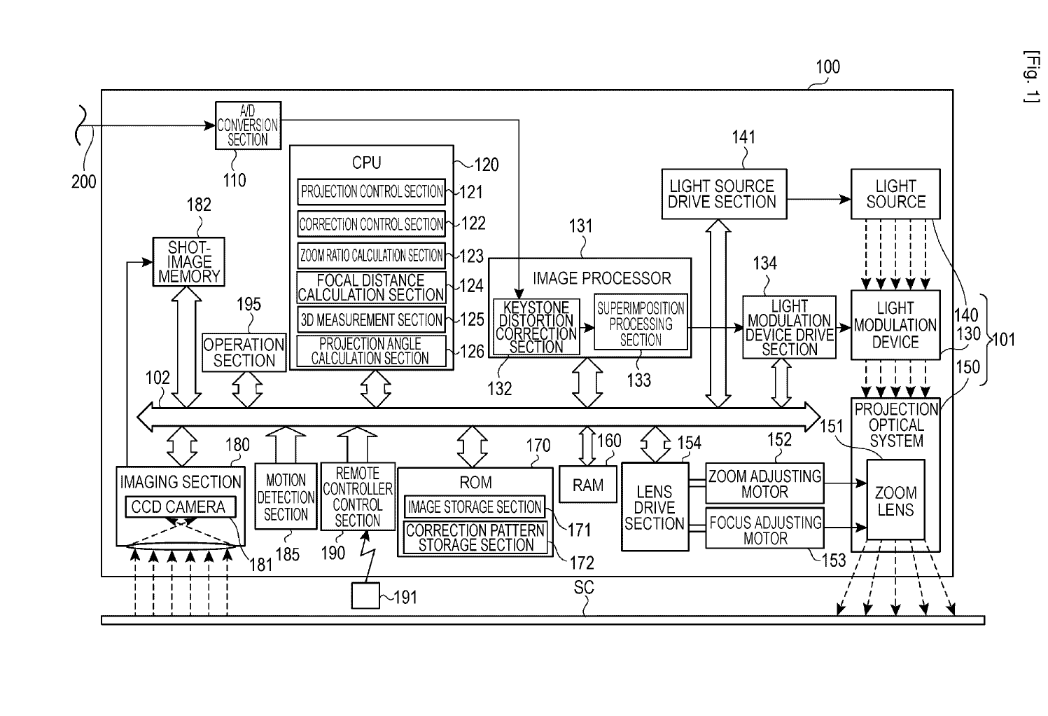

FIG. 1 is a block diagram showing an overall configuration of a projector 100 according to the first embodiment. The projector 100 projects an image on a screen SC based on the image data stored in an image storage section 171 incorporated therein, or image data input from an external image supply device (not shown) such as a personal computer or various types of video players. In the present embodiment, the screen SC stands roughly upright, and the screen surface has a rectangular shape.

The image data input to the projector 100 can be either of data of a moving image (a video) and data of a still image, and the projector 100 is capable of projecting the video on the screen SC and of continuously projecting the still image on the screen SC. In the embodiment described below, the explanation is presented citing the case of projecting the image based on an analog signal input from an external image supply device via a cable 200 as an example.

In terms of a general classification, the projector 100 is composed of a projection section 101 (a projection unit) for performing optical image formation, and an image processing system for controlling overall function of the projector 100 to thereby electrically process the image signal. The projection section 101 is composed of a light source 140, a light modulation device 130, and a projection optical system 150. As the light source 140, there can be used a xenon lamp, a super-high pressure mercury lamp, a light emitting diode (LED), a laser source, and so on. It should be noted that the light source 140 can also be provided with a reflector and an auxiliary reflector for guiding the light emitted by the light source 140 to the light modulation device 130, a light control element (not shown) for dimming the light emitted by the light source 140 on the path reaching the light modulation device 130, and so on.

The light modulation device 130 receives a signal from an image processing system described later, and then modulates the light emitted by the light source 140 to thereby form the image light. As a specific configuration of the light modulation device 130, there can be cited, for example, a system using three transmissive or reflective liquid crystal light valves corresponding to the respective colors of RGB. In this case, the light emitted by the light source 140 is separated by a dichroic mirror and so on into the colored lights of R, G, and B, and then enters the light modulation device 130, the colored lights are modulated by the liquid crystal panels of the respective colors provided to the light modulation device 130, then the colored lights are combined by a cross dichroic prism, and then guided to the projection optical system 150. In the present embodiment, the configuration in which the light modulation device 130 is provided with the transmissive liquid crystal panels is adopted. The light modulation device 130 is driven by alight modulation device drive section 134 described later, and varies the light transmission in each of pixels arranged in a matrix to thereby form the image.

The projection optical system 150 is provided with a zoom lens 151 for performing expansion and contraction of the image to be projected and adjustment of the focus, a zoom adjusting motor 152 for adjusting the level of the zoom, and a focus adjusting motor 153 for performing the focus adjustment. The light modulated by the light modulation device 130 enters the projection optical system 150, and then projected on the screen SC via the zoom lens 151 to thereby form the projection image. The zoom lens 151 is formed of a lens group including a plurality of lenses. The zoom adjusting motor 152 and the focus adjusting motor 153 drive the zoom lens 151 to perform the positioning of each of the lenses and the like to thereby perform the zoom control for expanding and contracting the projection image on the screen SC and the focus adjustment for appropriately form the projection image on the screen SC.

The image processing system is configured with a CPU 120 for integrally controlling the entire projector 100, and an image processor 131 as the core constituents, and is provided with an A/D conversion section 110, the light modulation device drive section 134, a light source drive section 141, a lens drive section 154, a RAM 160, a ROM 170 including the image storage section 171 and a correction pattern storage section 172, an imaging section 180 having a CCD camera 181, a shot-image memory 182, a motion detection section 185, a remote controller control section 190, a remote controller 191, an operation section 195, and so on. These constituents constituting the image processing system are connected to each other via a bus 102.

The A/D conversion section 110 is a device for performing the A/D conversion on the analog input signal input from the external image supply device described above via the cable 200, and outputs a digital signal obtained by the conversion to the image processor 131.

The CPU 120 performs the image processing in the projector 100 together with the image processor 131. The CPU 120 is provided with a correction control section 122, a zoom ratio calculation section 123, a focal distance calculation section 124, a three-dimensional (3D) measurement section 125, and a projection angle calculation section 126 in addition to a projection control section 121 for performing the control related to the projection by the projector 100. These sections are each realized by the CPU 120 performing a program previously stored in the ROM 170. The CPU 120 functions as a controller, and in particular the function of the projection control section 121 corresponds to the controller.

The image processor 131 is provided with a keystone distortion correction section 132 and a superimposition processing section 133. The image processor 131 processes the image data input from the A/D conversion section 110 due to the control by the CPU 120 to thereby generate the image signal used by the light modulation device 130 for drawing the projection image, and then output it to the light modulation device drive section 134. The image processor 131 can be configured using a general purpose processor sold as a digital signal processor (DSP) for keystone distortion correction or image processing, or can be configured as a dedicated ASIC. Further, in the case in which the projector 100 projects the image data stored in the image storage section 171, the image processor 131 performs the process described above on the image data.

The light modulation device drive section 134 drives the light modulation device 130 based on the image signal input from the image processor 131. Thus, the image corresponding to the image signal thus input to the A/D conversion section 110 is formed in the image forming area of the light modulation device 130, and then the image is formed on the screen as the projection image via the projection optical system 150.

The light source drive section 141 applies a voltage to the light source 140 in accordance with an instruction signal input from the CPU 120 to thereby put the light source 140 on or off.

The lens drive section 154 drives the zoom adjustment motor 152 and the focus adjustment motor 153 due to the control by the CPU 120 to thereby perform the zoom adjustment and the focus adjustment.

The RAM 160 forms a work area for temporarily storing the programs to be executed by the CPU 120 and the image processor 131 and the data. It should be noted that the image processor 131 can also be provided with the work area, which becomes necessary when performing each process such as a process for adjusting the display state of the image to be performed by itself, as an internal RAM.

The ROM 170 stores the programs executed by the CPU 120 for realizing the respective processing sections described above, the data related to the programs, and so on. Further, the ROM 170 is provided with the image storage section 171 for storing the image to be projected by the projection section 101, and the correction pattern storage section 172 storing the correction pattern used for the distortion correction process described above.

The imaging section 180 is provided with the CCD camera 181 using CCD as an image sensor well known to the public. The imaging section 180 is disposed at a position where the CCD camera 181 can image the front of the projector, namely the direction in which the projection optical system 150 projects the image toward the screen SC. In the imaging section 180, the direction and the field angle of the CCD camera 181 are set so that the entire projection image projected on the screen SC in a recommended projection distance falls within at least the imaging range. The CCD camera 181 can also be provided with a single focus lens for forming the image on the CCD, a mechanism such as an automatic iris mechanism for adjusting the intensity of the light entering the CCD, and further a control circuit or the like for reading out the image signal from the CCD, in addition to the CCD. The data of the shot image shot by the CCD camera 181 is output from the imaging section 180 to the shot-image memory 182, and is repeatedly written to a predetermined area of the shot-image memory 182. Since the shot-image memory 182 sequentially reverses a flag of the predetermined area when writing of the image data corresponding to one frame is completed, the CPU 120 can know whether or not the imaging using the imaging section 180 is completed by looking up the flag. The CPU 120 looks up the flag, and then accesses the shot-image memory 182 to thereby obtain the necessary shot-image data.

The motion detection section 185 is provided with a gyro sensor and an acceleration sensor to detect the motion of the main body of the projector 100, and then outputs the detection value to the CPU 120. A threshold value is previously set to the detection value of the motion detection section 185, and if the motion exceeding the threshold value is detected by the motion detection section 185, the CPU 120 determines that the projector 100 moves. Further, if the motion detected by the motion detection section 185 is equal to or lower than the threshold value, and this state continues for a period exceeding a standby period set in advance, the CPU 120 determines that the projector stops.

It should be noted that it is also possible to adopt the configuration in which the motion detection section 185 outputs the detection signal to the CPU 120 if the threshold value is set to the motion detection section 185, and the detection value of the motion detection section 185 exceeds the threshold value, or the standby period has elapsed after the detection value of the motion detection section 185 becomes equal to or lower than the threshold value, and in this case, the load of the CPU 120 can be reduced.

The remote controller control section 190 receives a wireless signal transmitted from the remote controller 191 located outside the projector 100. The remote controller 191 is provided with an operator (not shown) operated by the user, and transmits an operation signal corresponding to the operation to the operator as an infrared signal or a wireless signal using a radio wave with a predetermined frequency. The remote controller control section 190 is provided with a light receiving section (not shown) for receiving the infrared signal and a receiving circuit (not shown) for receiving the wireless signal, and receives and then analyzes the signal transmitted from the remote controller 191, then generates the signal representing the content of the operation by the user, and then outputs the signal to the CPU 120.

The operation section 195 is formed of, for example, the operator (not shown) of the operation panel provided to the main body of the projector 100. When detecting the operation to the operator described above, the operation section 195 outputs an operation signal corresponding to the operator to the CPU 120. As such an operator, there can be cited a switch for instructing power ON/OFF, a switch for instructing start of distortion correction process, and so on.

Here, the functions of the CPU 120 and the image processor 131 will be explained.

The projection control section 121 controls the action of projecting the image by the projection section 101 based on the image data output by the A/D conversion section 110. Specifically, the projection control section 121 performs the control of putting on or off the light source 140 using the light source drive section 141 due to the power ON/OFF of the projector 100, the control of making the image processor 131 process the image data output by the A/D conversion section 110, and so on.

Further, the projection control section 121 has a function of controlling the keystone distortion correction section 132 using the correction control section 122 to start and terminate the distortion correction process for correcting the keystone distortion. Here, the correction control section 122 functions as a correction unit in cooperation with the keystone distortion correction section 132.

As the start condition for starting the distortion correction process, there is set in advance, for example, the condition in which the motion of the projector 100 is detected based on the detection value of the motion detection section 185, or the condition in which the distortion correction process is instructed by the operation of the operation section 195 or the remote controller 191. When either of the conditions thus set is satisfied, the projection control section 121 determines that the start condition of the distortion correction process is fulfilled, and controls the superimposition processing section 133 of the image processor 131 to project a correction pattern (a correcting image) stored in the correction pattern storage section 172 so as to be superimposed on the image presently projected. Thus, the image having been projected since a time point before the start of the distortion correction process and the correction pattern are displayed on the screen SC in a superimposed manner.

Then, the projection control section 121 makes the correction control section 122 perform the distortion correction process. The correction control section 122 makes the imaging section 180 take the projection image in the state in which the correction pattern stored in the image storage section 171 is projected on the screen SC. The correction control section 122 obtains the shot image data from the shot-image memory 182, and then makes the projection angle and the projection distance be calculated based on the shot-image data due to the functions of the respective processing sections, namely the zoom ratio calculation section 123, the focal distance calculation section 124, the 3D measurement section 125, and the projection angle calculation section 126. Further, the correction control section 122 outputs the control data corresponding to the projection angle to the image processor 131, and at the same time controls the lens drive section 154 in accordance with the projection distance to perform the focus adjustment.

Further, the correction control section 122 calculates parameters for performing the distortion correction process based on the projection angle and the projection distance calculated due to the functions of the respective processing sections, namely the zoom ratio calculation section 123, the focal distance calculation section 124, the 3D measurement section 125, and the projection angle calculation section 126. The parameters are those for deforming the image to be drawn by the light modulation device 130 so as to correct the distortion of the projection image on the screen SC, and are the data defining the direction of the deformation, the deformation amount, and so on. The correction control section 122 outputs the parameters thus calculated to the keystone distortion correction section 132, and makes the keystone distortion correction section 132 perform the distortion correction process.

The processing sections, namely the zoom ratio calculation section 123, the focal distance calculation section 124, the 3D measurement section 125, and the projection angle calculation section 126, perform the processes necessary for calculating the relative distance (hereinafter referred to as a projection distance) between the projector 100 and the screen SC, and the projection angle, which is the tilt of the light axis of the projection light projected from the projector 100 with respect to the plane of the screen SC, in accordance with the control by the correction control section 122.

The image processor 131 is a functional section for processing the image data input from the A/D conversion section 110. The image processor 131 performs the process for adjusting the display state of the image such as luminance, contrast, color depth, and color on the image data of the projection object, and then outputs the image data having been processed to the light modulation device drive section 134.

The keystone distortion correction section 132 provided to the image processor 131 performs the process of deforming the image of the image data, which is output by the A/D conversion section 110, in accordance with the parameters input from the correction control section 122.

The superimposition processing section 133 has the function of superimposing the correction pattern stored in the correction pattern storage section 172 on the projection image. Here, the superimposition processing section 133 is connected to the keystone distortion correction section 132 as the posterior stage thereof, and the image data having been processed by the keystone distortion correction section 132 is input to the superimposition processing section 133. Therefore, in both of the case in which the keystone distortion correction section 132 has performed the distortion correction process and the case in which the keystone distortion correction section 132 has not performed the distortion correction process, the superimposition processing section 133 superimposes the correction pattern on the image data having passed through the keystone distortion correction section 132. Further, according to this configuration, there is no chance of performing the distortion correction process on the image on which the superimposition processing section 133 has superimposed the correction pattern. In other words, the correction pattern to be projected by the projector 100 is always in the state in which the distortion correction process is not performed thereon.

Next, an action of the projector 100 will be explained.

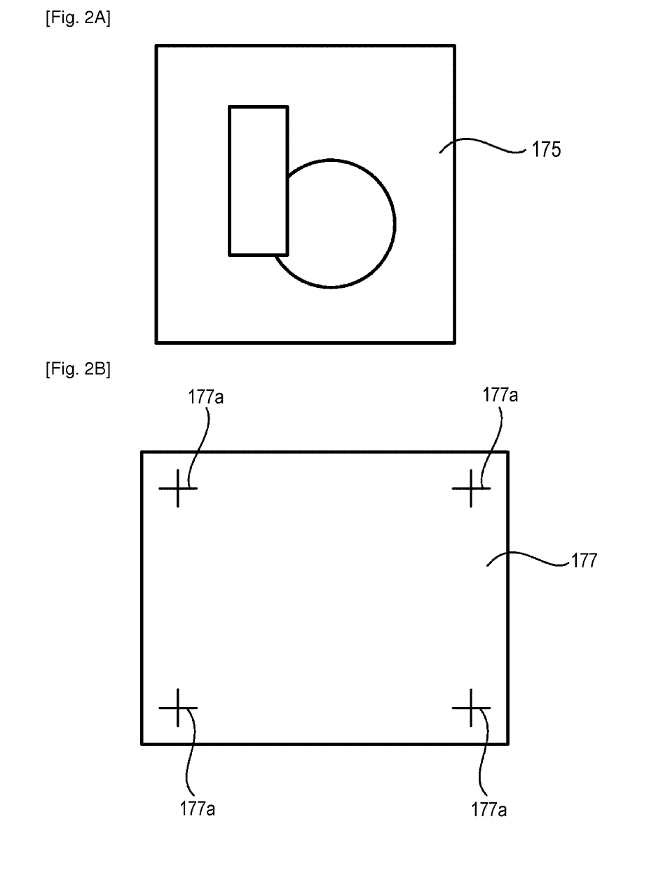

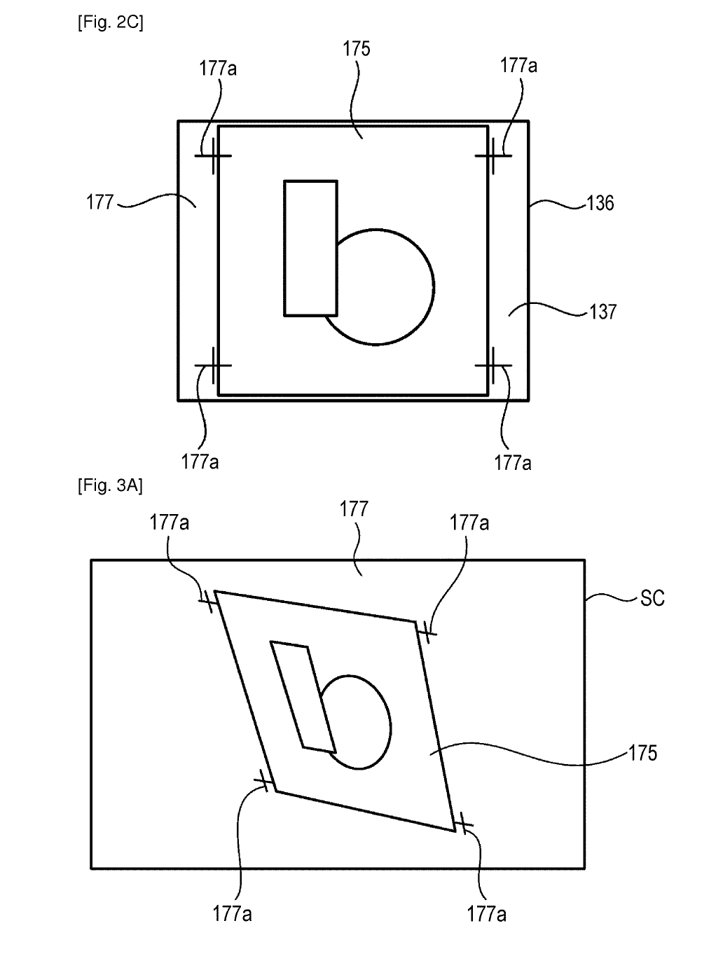

FIGS. 2A through 2C are explanatory diagrams showing an action of the projector 100 projecting the image and the correction pattern. FIG. 2A shows an example of the image, and FIG. 2B shows an example of the correction pattern. Further, FIG. 2C shows an example in which the light modulation device 130 draws the image and the correction pattern in an image formable area 136.

In the present embodiment, an example of projecting a rectangular image 175 as shown in FIG. 2A will be explained. Further, as an example of the correction pattern, in the present embodiment, a correction pattern 177 shown in FIG. 2B will be cited. The correction pattern 177 has crisscross markers 177a disposed in the vicinities of the four corners, respectively, and forms a rectangular shape as a whole. The part other than the markers 177a is colorless (transparent).

If the superimposition processing section 133 superimposes the correction pattern 177 on the image 175 in the state in which the keystone distortion correction section 132 performs no distortion correction process, the image shown in FIG. 2C is drawn in the image formable area 136 of the light modulation device 130. As shown in FIG. 2C, in the state of performing no distortion correction process, the image is drawn using a large part of the image formable area 136 of the light modulation device 130. Therefore, an image forming area 137 is disposed in the whole of the image formable area 136, and the image 175 is formed (drawn) in the image forming area 137. Further, the correction pattern 177 is drawn in the image forming area 137 so as to be superimposed on the image 175. Since the correction pattern 177 is transparent except the markers 177a, the markers 177a are drawn so as to be superimposed on the image 175.

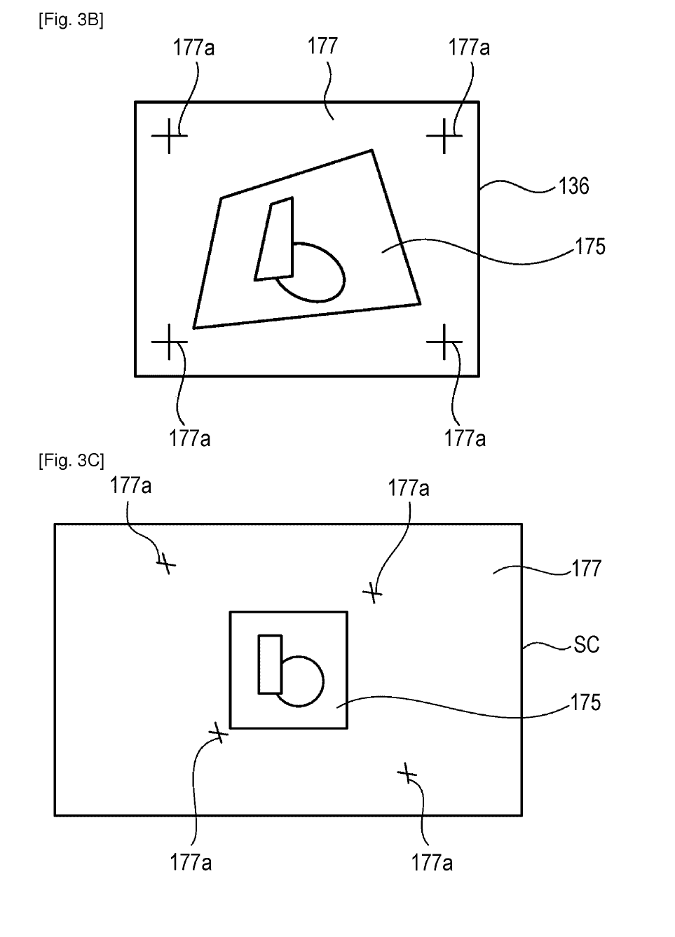

FIGS. 3A through 3C are explanatory diagrams showing an example of an action of the projector 100 correcting the distortion of the projection image, wherein FIG. 3A shows a projection example to the screen SC before the correction, FIG. 3B shows an example of the image formed in the image formable area 136, and FIG. 3C shows a projection example to the screen SC after the correction.

The image projected on the screen SC has a keystone distortion as shown in FIG. 3A due to the installation angle of the projector 100 with respect to the screen SC. FIG. 3A shows an example of projecting the image obtained by superimposing the correction pattern 177 on the image 175 as shown in FIG. 2C. In this example, the image 175 is projected with a distortion, and the positions of the markers 177a are shifted from the rectangular arrangement in accordance with the keystone distortion.

Here, when the distortion correction process by the correction control section 122 is performed, the keystone distortion correction section 132 deforms the image 175. Thus, since the image output from the image processor 131 to the light modulation device drive section 134 includes the deformed image 175, the deformed image 175 as shown in FIG. 3B is drawn in the image forming area 137 of the light modulation device 130. Further, since it is necessary to draw the deformed image 175 inside the rectangular image formable area 136, the image forming area 137 in which the image 175 is drawn is a part of the image formable area 136.

As described above, since the superimposition processing section 133 connected to the keystone distortion correction section 132 in the posterior stage thereof superimposes the correction pattern 177 on the image output by the keystone distortion correction section 132, on which the distortion correction process has been performed, the distortion correction process is not performed on the correction pattern 177. Therefore, as shown in FIG. 3B, the four markers 177a respectively disposed at the four corners of the rectangular shape are drawn in the image 175 in the same state as the state shown in FIG. 2C in which no distortion correction process has been performed.

Therefore, as shown in FIG. 3C, although the image 175 is projected with a rectangular shape to the screen SC in the state in which the keystone distortion is corrected, the correction pattern 177 remains to keep the state of the keystone distortion. In other words, the positions of the markers 177a are shifted from the positions without the keystone distortion.

When correcting the keystone distortion, the correction control section 122 makes the imaging section 180 shoot the screen SC, detects the positions of the markers 177a from the shot image, and then performs the calculation by the zoom ratio calculation section 123, the focal distance calculation section 124, the 3D measurement section 125, and the projection angle calculation section 126 based on the positions. Then, the correction control section 122 calculates the parameters for the distortion correction based on these calculation results, and then sets the parameters thus calculated to the keystone distortion correction section 132. In the series of processes, the correction control section 122 compares the positions of the markers 177a detected in the shot-image data of the imaging section 180 with the positions of the markers 177a in the data of the correction pattern 177 stored in the correction pattern storage section 172.

Therefore, in the case of further performing the distortion correction process after the distortion correction process has been performed as shown in FIG. 3C, the screen SC is newly shot by the imaging section 180, then the markers 177a are detected from the new shot-image data, and then the parameters are calculated.

However, if not only the image 175 but also the correction pattern 177 are deformed with the parameters when performing the distortion correction process, the markers 177a are moved by the distortion correction process. Therefore, the positions of the markers 177a on the screen SC are determined by a process performed by the keystone distortion correction section 132 in addition to the installation angle and the distance between the screen SC and the projector 100. Therefore, if the markers 177a moved by the keystone distortion correction section 132 are shot, and the positions of the markers 177a in the shot-image data are compared with the positions of the markers 177a in the correction pattern 177 stored in the correction pattern storage section 172, it is not achievable to correctly obtain the installation angle and the distance between the screen SC and the projector 100. In this case, in order to correctly obtain the installation angle and the distance, it is necessary to perform a process of eliminating the influence of the distortion correction process having been previously performed.

Due to the control by the projection control section 121, if the projector 100 determines that the start condition of the distortion correction process is satisfied, the projector 100 performs the distortion correction process before the projector 100 stops, and thereafter, repeatedly performs the distortion correction process with a predetermined period until the condition for completing the distortion correction process is satisfied. Thus, since the distortion correction process is periodically (every time a predetermined period elapses) performed, and the image on which the correction is performed is periodically projected on the screen SC, the user can see the state of the correction even before the projector stops or the operation for completing the distortion correction is performed. Further, since the distortion correction process is performed in the state in which the projector 100 stops after the movement of the projector 100 has stopped and before the standby period elapses, the image corrected in accordance with the position where the projector 100 stops is projected on the screen SC. Thus, the image with the correction completed can be projected before the standby period substantially elapses, and the image without the distortion can promptly be projected. In this case, it is preferable that the period with which the projector 100 repeatedly performs the distortion correction process is shorter than the standby period described above.

In the case of continuously performing the distortion correction a plurality of times as described above, if the distortion correction process is also applied to the correction pattern 177, there arises the necessity of performing the calculation for eliminating the influence of the distortion correction a plurality of times with respect to the positions of the markers 177a, and the load of the process for calculating the parameters increases. Therefore, if it is arranged that the distortion correction process is not performed on the correction pattern 177 as in the present embodiment, the positions of the markers 177a always correspond to the positions shifted as much as the value reflecting the installation angle and the distance between the screen SC and the projector 100. Therefore, even if the distortion correction process is repeatedly performed, the installation angle and the distance between the screen SC and the projector 100 can promptly and accurately be obtained based on the positions of the markers 177a, and thus, the accurate parameters can be calculated. The load of the process for calculating the parameters does not increase if the distortion correction process is repeatedly performed. Further, in the present embodiment, the superimposition processing section 133 for performing the process of superimposing the correction pattern 177 on the image to be projected by the projection section 101 is connected to the keystone distortion correction section 132 for performing the distortion correction process in the posterior stage thereof, and the image on which the superimposition processing section 133 performs the superimposition process is output to the light modulation device drive section 134, and is then drawn in the light modulation device 130. Therefore, since the procedure of the process in the projector 100 is arranged to be the procedure with which the correction pattern 177 is not affected by the distortion correction process, it is possible to arrange that the correction pattern 177 is not deformed by the distortion correction process without performing a special process.

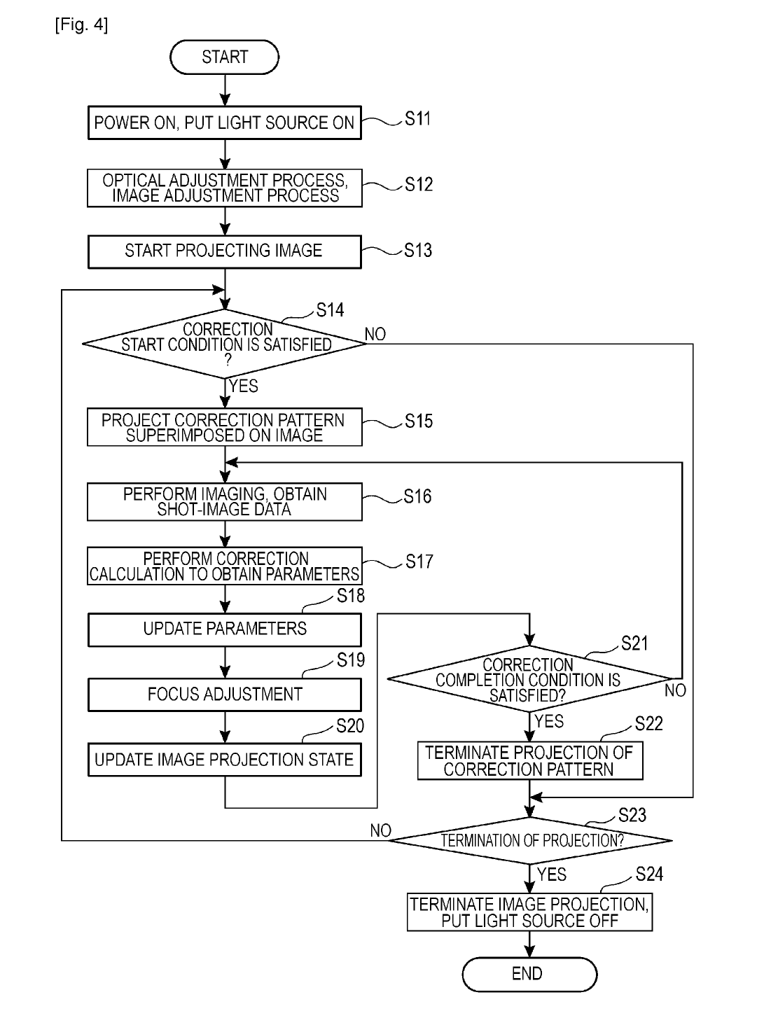

FIG. 4 is a flowchart showing the action of the projector 100.

When the power of the projector 100 is switched to the ON state, the CPU 120 of the projector 100 controls the light source drive section 141 to put the light source 140 on (step S11). Further, the CPU 120 controls the lens drive section 154 to perform the optical adjustment in the projection optical system 150, and at the same time, makes the image processor 131 perform adjustment of the brightness of the image, adjustment corresponding to the designated color mode, and so on (step S12). Subsequently, the projection control section 121 provided to the CPU 120 projects (step S13) the image output from the A/D conversion section 110.

After starting the projection, the projection control section 121 determines (step S14) whether or not the start condition of the distortion correction process is satisfied. As described above, the start condition is either of the fact that the start instruction operation by the remote controller 191 or the operation section 195 is performed and the fact that the detection value of the motion detection section 185 exceeds the threshold value. If the start condition of the distortion correction process is satisfied (YES in the step S14), the projection control section 121 reads out the correction pattern stored in the correction pattern storage section 172, then makes the superimposition processing section 133 superimpose the image, and then makes the correction pattern be projected on the screen SC (step S15).

Subsequently, the correction control section 122 makes the imaging section 180 shoot the screen SC, and then obtains the shot-image data from the shot-image memory 182 (step S16). The correction control section 122 detects the markers of the correction pattern in the shot-image data, and performs the calculation by the zoom ratio calculation section 123, the focal distance calculation section 124, the 3D measurement section 125, and the projection angle calculation section 126 to thereby calculate the parameters for correcting the keystone distortion caused in the image on the screen SC (step S17). The correction control section 122 updates (step S18) the parameters set to the keystone distortion correction section 132 with the new parameters, and then makes the keystone distortion correction section 132 perform the distortion correction process on the image presently projected. Further, the correction control section 122 controls the lens drive section 154 based on the value calculated from the positions of the markers to perform the focus adjustment (step S19). Subsequently, the distortion correction process based on the new parameters is performed by the keystone distortion correction section 132, and the image obtained by the superimposition processing section 133 superimposing the correction pattern on the image having been processed is projected on the screen SC (step S20).

The projection control section 121 determines (step S21) whether or not the condition for completing the distortion correction process is satisfied. As described above, the condition for completing the distortion correction process is either of the fact that the instruction operation for completing the distortion correction process is performed by the remote controller 191 or the operation section 195 and the fact that the standby period elapses after the detection value of the motion detection section 185 has reached a value equal to or lower than the threshold value. If either of the conditions has not yet been satisfied (NO in the step S21), the process returns to the step S16. Subsequently, since the processes on and after the step S17 are performed again, the projector 100 performs the distortion correction process in real time during the period from when the start condition of the distortion correction process has been satisfied to when the condition for completing it is satisfied. In other words, it results that the distortion correction process is performed a plurality of times (i.e., two or more times) during the period from when the start condition of the distortion correction process has satisfied to when the condition for completing the distortion correction process is satisfied. In other words, a plurality of distortion correction processes are continuously performed during the period from when the start condition of the distortion correction process has satisfied to when the condition for completing the distortion correction process is satisfied. In contrast, if the condition for completing the distortion correction process is satisfied (YES in the step S21), the projection control section 121 makes the superimposition processing section 133 terminate (step S22) the process of superimposing the correction pattern, and then the projection control section 121 determines (step S23) whether or not the projector 100 terminates the projection, and if it does not terminate the projection (NO in the step S23), the process returns to the step S14. Further, if the projector 100 terminates the projection in accordance with the operation of the remote controller 191 or the operation section 195 (YES in the step S23), the projection control section 121 terminates the action related to the image projection by the projection section 101, and puts the light source 140 off (step S24).

Further, if the start condition of the distortion correction process is not satisfied (NO in the step S14), the process proceeds to the step S23 to determine whether or not the projection is terminated. It should be noted that if the projection is not terminated in the step S23, the process returns to the step S14 to repeatedly determine whether or not the start condition is satisfied, and the period of the determination in the step S14 is set in advance. In other words, during the period in which the start condition is not satisfied and the projection is not terminated, the determination is repeatedly performed with the set period.

As explained hereinabove, according to the projector 100 related to the first embodiment to which the invention is applied, the projection section 101 for projecting the image on the screen SC, the CPU 120 for making the projection section 101 project the correction pattern superimposed on the image presently projected if the start condition of the distortion correction process for correcting the distortion of the image projected by the projection section 101 is satisfied, and the correction control section 122 and the keystone distortion correction section 132 for performing the distortion correction process based on the state of the correction pattern projected by the projection section 101 are provided, and the CPU 120 makes the correction pattern be projected in the state in which the result of the distortion correction process is not reflected during the period from when the start condition of the distortion correction process has been satisfied to when the condition for completing the distortion correction process is satisfied, and the period in which the keystone distortion correction section 132 performs the distortion correction process a plurality of times. Therefore, if the distortion correction is performed based on the state of the correction pattern projected on the screen SC, the correction pattern is projected until the distortion correction process is completed without reflecting the distortion correction process on the correction pattern. Thus, when performing the distortion correction process a plurality of times, the distortion correction can be performed without adding the correction having already been performed. Therefore, it is possible to perform the process of correcting the distortion of the projection image on the screen SC a plurality of times, and at the same time reduce the load of the arithmetic processing related to the correction.

Further, when the keystone distortion correction section 132 performs the distortion correction process, the projection control section 121 provided to the CPU 120 makes the correction pattern be projected in the state in which the result of the distortion correction process is not reflected, while updating the projection state of the image presently projected so as to reflect the result of the distortion correction process. Therefore, it is possible to inform the user of the change in the image due to the distortion correction process in real time without waiting for the completion of the series of distortion correction processes.

Further, the projection control section 121 determines that the start condition of the distortion correction process is satisfied based on the motion of the projector 100 detected by the motion detection section 185 or the operation of the remote controller 191 or the operation section 195. Therefore, it is possible to promptly start the distortion correction process, and perform, for example, the distortion correction process a plurality of times while reducing the load of the processing.

Further, since the projection control section 121 determines that the condition for completing the distortion correction process is satisfied based on the motion of the projector 100 or the external operation, it is possible to continuously perform the distortion correction process during the period before the condition is satisfied to thereby surely and accurately correct the distortion of the projection image. Further, since the distortion correction process is performed a plurality of times and the corrected image is projected on the screen SC without waiting for the completion of the distortion correction process, there is no chance of waiting the user viewing the distorted image. Therefore, since the convenience is not degraded even if the condition for completing the distortion correction process is set to be strict, by setting the condition so that the distortion correction process is completed when the projector 100 more surely stops, the keystone distortion can more surely be corrected.

In the first embodiment, the projector 100 has the configuration in which the image is corrected by the keystone distortion correction section 132 and the image thus corrected is projected on the screen SC before the condition for completing the distortion correction process is satisfied, and if the distortion correction is performed a plurality of times, the image projected on the screen SC is updated every time the distortion correction process is performed. According to this configuration, if the projector 100 is moved violently, the change in the image becomes rapid. Therefore, it is also possible to perform a process of suppressing a steep change in the image before the condition for completing the distortion correction process is satisfied. Specifically, if the keystone distortion correction section 132 performs the distortion correction process, the projection control section 121 makes the projection state of the image presently projected be updated so as to be in a middle state between the state after reflecting the distortion correction process and the state before reflecting the distortion correction process. Specifically, every time the distortion correction process is performed, it is also possible to generate the middle image between the image corrected with the parameters calculated by the correction control section 122 in the distortion correction process and the image having been projected before the distortion correction process, and then draw the middle image in the light modulation device 130 to thereby project it on the screen SC. Then, it is possible to continue the action of projecting the middle image described above before the condition for completing the distortion correction process is satisfied, and then directly project the image corrected in accordance with the parameters calculated by the correction control section 122 after the condition for completing the distortion correction process is satisfied. In this case, since the level of the change in the image can be lowered during the period until the condition for completing the distortion correction process is satisfied, even if the projector 100 is moved violently, the impression provided to the user can be reduced.

### Second Embodiment

A second embodiment to which the invention is applied will hereinafter be explained. In the second embodiment, there is explained a configuration of projecting the outline representing the shape of the image after the distortion correction process on the screen SC instead of the image on which the distortion correction process is performed during the period in which the distortion correction process is repeatedly performed. It should be noted that in the second embodiment, the sections of the projector 100 are configured similarly to those of the first embodiment described above, and are therefore denoted with the same reference symbols, and the explanation therefor will be omitted.

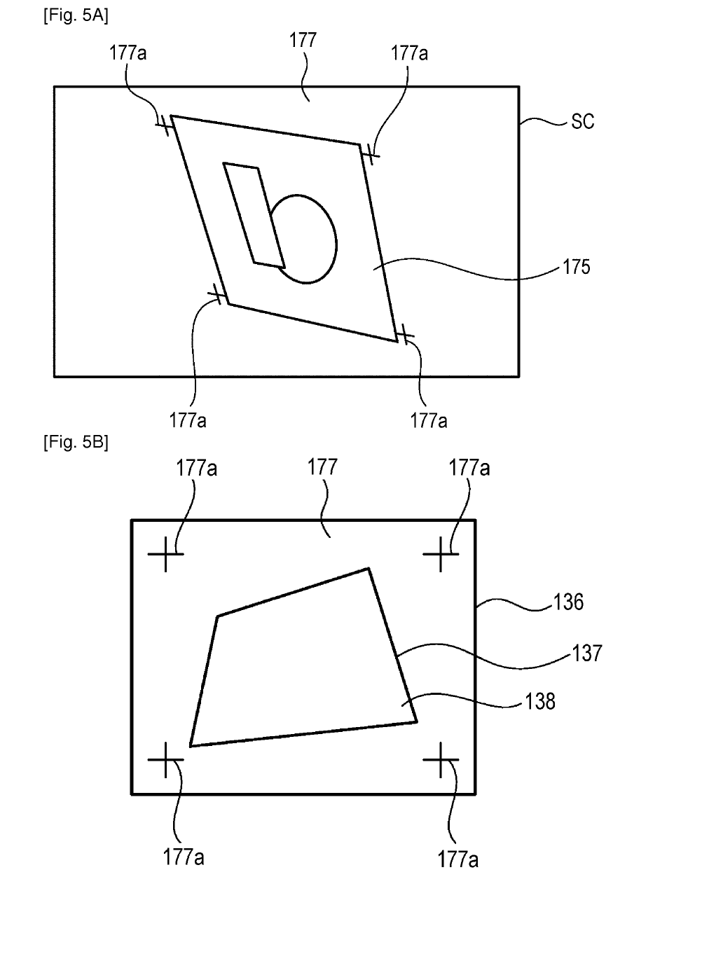

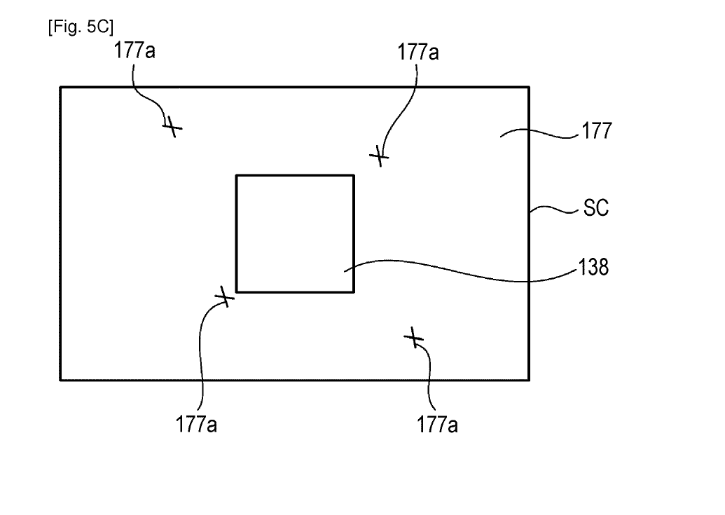

FIGS. 5A through 5C are explanatory diagrams showing an example of the action of the projector 100 according to the second embodiment correcting the distortion of the projection image. FIG. 5A shows a projection example to the screen SC before the correction, FIG. 5B shows an example of the image formed in the image formable area 136 of the light modulation device 130, and FIG. 5C shows a projection example to the screen SC after the correction.

There is assumed the case in which the state of projecting the correction pattern 177 superimposed on the image 175 on the screen SC causes the keystone distortion as shown in FIG. 5A when starting the distortion correction process. In this case, the correction control section 122 makes the imaging section 180 perform shooting, and then calculates the parameters for correction based on the positions of the markers 177a in the shot-image data. In the present embodiment, although the keystone distortion correction section 132 performs the process of deforming the shape of the image forming area 137 for drawing the image 175, namely the corrected outline of the image 175, based on the parameters calculated by the correction control section 122, the process is not performed inside the image 175, and the inside of the image 175 is assumed to be blank. In other words, although the outline 138 representing the contour of the image 175 corrected by the distortion correction process is drawn in the image formable area 136 of the light modulation device 130 as shown in FIG. 5B, the image 175 is not drawn. Further, the correction pattern 177 on which the distortion correction process is not performed is drawn so as to be superimposed on the outline 138.

If the projection on the screen SC is performed in this state, the outline 138 corrected is imaged on the screen SC as a rectangular shape as shown in FIG. 5C. Further, the correction pattern 177 is projected having the shape without the correction.

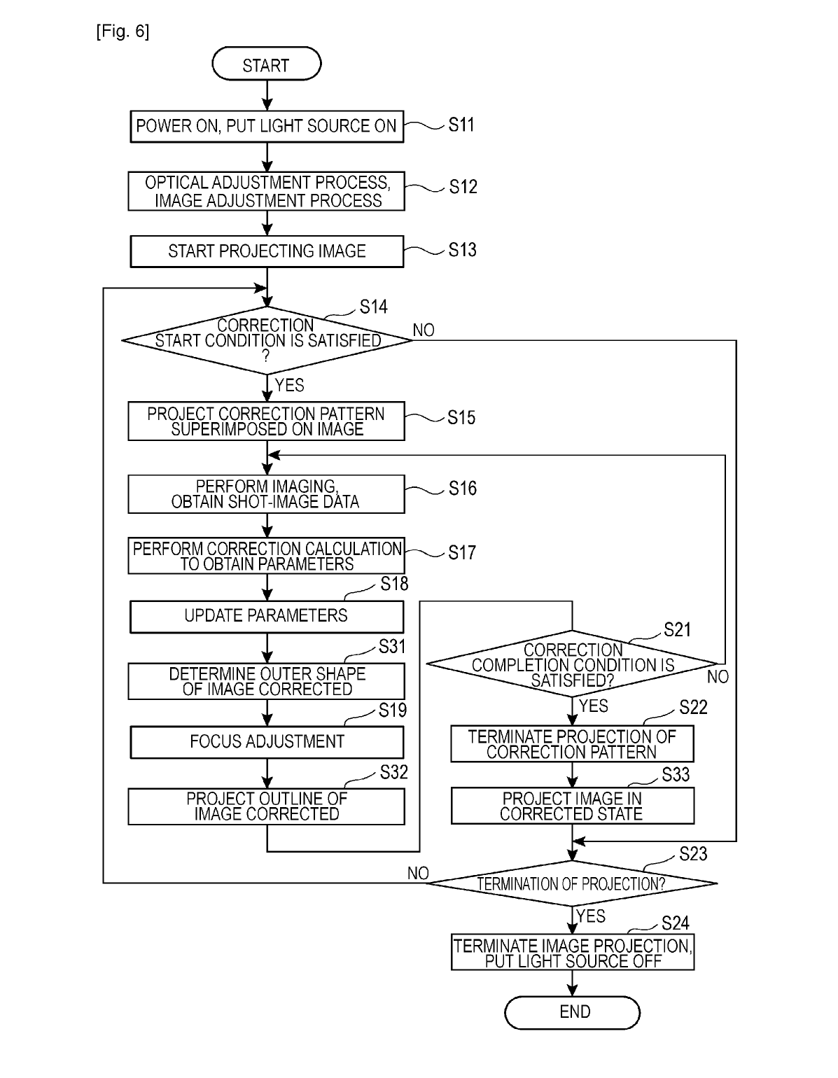

FIG. 6 is a flowchart showing an action of the projector 100 according to the second embodiment. In FIG. 6, the same processes as those explained with reference to FIG. 4 are denoted with the same step numbers.

In the action shown in FIG. 6, in the projector 100, after the correction control section 122 updates the parameters of the keystone distortion correction section 132 in the step S18, the keystone distortion correction section 132 performs the process of deforming the shape of the image 175 in accordance with the parameters thus updated, then determines the outer shape, and then generates the image of the outline (step S31).

Then, after the correction control section 122 performs the focus adjustment in the step S19, the outline generated by the keystone distortion correction section 132 is drawn in the light modulation device 130, and is then projected on the screen SC (step S32).

Thus, since the keystone distortion correction section 132 is not required to perform the conversion process on all of the pixels constituting the image 175, the load of the distortion correction process can significantly be reduced. Therefore, it is possible to repeatedly perform the distortion correction process with a short period and update the image to be projected on the screen SC during the period, for example, from when the start condition of the distortion correction process is satisfied in the step S14 to when the completion condition is satisfied in the step S21. Further, since it is possible for the user to know whether or not the state of the keystone distortion correction is preferable if the outline 138 is projected on the screen SC, sufficient information can be provided to the user only with the outline 138.

Subsequently, the projection control section 121 determines in the step S21 that the completion condition of the distortion correction process is satisfied, terminates the projection of the correction pattern 177 in the step S22, then makes the keystone distortion correction section 132 perform the process of deforming the whole of the image 175 in accordance with the parameters thus set, and then projects the whole of the image 175 thus corrected on the screen SC (step S33). Thus, the projection of the outline 138 having been projected on the screen SC is terminated, and the image 175 is projected in the corrected state. In other words, the transition to the normal projection state is promptly made after the completion of the distortion correction.

As described above, according to the projector 100 related to the second embodiment, when the keystone distortion correction section 132 performs the distortion correction process, the correction pattern 177 is projected in the state of not reflecting the result of the distortion correction process, and at the same time, the outline 138 representing the shape of the image 175 on which the distortion correction process has been performed is projected. Thus, it is possible to inform the user of the change in the image by the distortion correction process without waiting for the completion of the series of the distortion correction processes, and at the same time, reduce the load related to the distortion correction process.

It should be noted that each of the embodiments described above is nothing more than an example of a specific aspect to which the invention is applied, and therefore, does not limit the invention. Therefore, it is also possible to apply the invention as an aspect different from the embodiments described above. For example, although in each of the embodiments described above the explanation is presented citing the case of projecting the image input to the A/D conversion section 110 via the cable 200 as an example, the invention is not limited thereto, but can obviously be applied to the case of projecting the image or the video stored in the image storage section 171. Further, although in each of the embodiments described above, the setting values related to the time, the threshold value, and so on for defining the actions of the respective sections of the projector 100 are previously stored in the ROM 170, it is also possible to adopt the configuration in which these setting values are stored in a storage medium or a device outside the projector 100, and then obtained by the projector 100 as the need arises, or the configuration in which the setting values are input in each case by the operation of the remote controller 191 or the operation section 195.

Further, although in each of the embodiments described above, the process of correcting the keystone distortion generated in the image on the screen SC is explained, the invention is not limited thereto, but can be applied to the process of, for example, correcting a distortion called a barrel distortion or a pin-cushion distortion.

Further, although in the embodiments described above the explanation is presented assuming that the imaging section 180 has the configuration including the CCD camera 181 provided with the CCD image sensors, the invention is not limited thereto, but CMOS sensors can also be used as the image sensors of the imaging section 180. Further, although in the embodiments described above the explanation is presented citing, as an example, the configuration of using the liquid crystal panel composed of the three transmissive or reflective liquid crystal panels corresponding to the respective colors of RGB as the light modulation device, the invention is not limited thereto, but can be configured using a system including one liquid crystal panel and a color wheel combined with each other, a system using three digital mirror devices (DMD) for modulating the colored lights of the respective colors of RGB, a system using one digital mirror device and a color wheel combined with each other, and so on. Here, in the case of using just one liquid crystal panel or DMD as a display section, the member corresponding to the combining optical system such as the cross dichroic prism is not necessary. Further, besides the liquid crystal panel or the DMD, any configuration capable of modulating the light emitted from the light source can be adopted without problems. Further, each of the functional sections shown in FIG. 1 is for showing the functional configuration of the projector 100, and the specific mounting forms are not particularly limited. In other words, it is not necessarily required to install the hardware corresponding individually to each of the functional sections, but it is obviously possible to adopt the configuration of realizing the functions of the plurality of functional sections by one processor executing the program. Further, a part of the function realized by software in the embodiments described above can also be realized by hardware, or a part of the function realized by hardware can also be realized by software.

### REFERENCE SIGNS LIST

100 projector
101 projection section (projection unit)
120 CPU (controller)
121 projection control section
122 correction control section (correction unit)
130 light modulation device
131 image processor
132 keystone distortion correction section (correction unit)
133 superimposition processing section
134 light modulation device drive section
170 ROM
172 correction pattern storage section
177 correction pattern (correcting image)
180 imaging section
185 motion detection section
191 remote controller
195 operation section
SC screen (projection surface)

1. A projector comprising:
a projection unit adapted to project an image on a projection surface;
a controller adapted to make the projection unit project a correcting image so as to be superimposed on the image presently projected if a start condition of a distortion correction process adapted to correct a distortion of the image projected by the projection unit is satisfied; and
a correction unit adapted to perform the distortion correction process based on a state of the correcting image projected by the projection unit,
wherein the controller makes the projection unit project the correcting image in a state in which a result of the distortion correction process fails to be reflected during a period from when the start condition of the distortion correction process is satisfied to when a condition for completing the distortion correction process is satisfied, and a period in which the correction unit performs the distortion correction process a plurality of times.

2. The projector according to claim 1, wherein
the controller makes the projection unit project the correcting image in the state in which the result of the distortion correction process fails to be reflected, and makes the projection unit update the projection state of the image presently projected so as to reflect the result of the distortion correction process if the correction unit performs the distortion correction process.

3. The projector according to claim 1 wherein
the controller makes the projection unit project the correcting image in the state in which the result of the distortion correction process fails to be reflected, and makes the projection unit update the projection state of the image presently projected so as to be an intermediate state between a state reflecting the distortion correction process and a state before reflecting the distortion correction process if the correction unit performs the distortion correction process.

4. The projector according to claim 1, wherein
the controller makes the projection unit project the correcting image in the state in which the result of the distortion correction process fails to be reflected, and performs projection of showing a shape of the image after the distortion correction process if the correction unit performs the distortion correction process.

5. The projector according to claim 1, wherein
the controller determines that the start condition of the distortion correction process is satisfied based on one of a motion of the projector and an external operation.

6. The projector according to claim 1, wherein
the controller determines that the condition for completing the distortion correction process is satisfied based on one of a motion of the projector and an external operation.

7. A method of controlling a projector including a projection unit adapted to project an image on a projection surface, the method comprising:
making the projection unit project a correcting image so as to be superimposed on the image presently projected if a start condition of a distortion correction process adapted to correct a distortion of the image projected by the projection unit is satisfied;
performing the distortion correction process based on a state of the correcting image projected; and
making the projection unit project the correcting image in a state in which a result of the distortion correction process fails to be reflected during a period from when the start condition of the distortion correction process is satisfied to when a condition for completing the distortion correction process is satisfied, and a period in which the distortion correction process is performed a plurality of times.
